(19) United States
(12) Patent Application Publication
(10) Pub. No.: US 2014/0137380 A1
(43) Pub. Date: May 22, 2014

(54) BUSBAR CUTTING UNIT AND INTERIOR ILLUMINATION DEVICE FOR VEHICLE

(71) Applicant: YAZAKI CORPORATION, Tokyo (JP)

(72) Inventor: Manabu SAKAI, Makinohara-shi (JP)

(73) Assignee: YAZAKI CORPORATION, Tokyo (JP)

(21) Appl. No.: 14/164,327

(22) Filed: Jan. 27, 2014

Related U.S. Application Data
(63) Continuation of application No. PCT/JP2012/069528, filed on Jul. 25, 2012.

(30) Foreign Application Priority Data
Jul. 28, 2011 (JP) 2011-165205

(51) Int. Cl. H01R 43/16; B60Q 3/00

(52) U.S. Cl. CPC H01R 43/16; B60Q 3/00
USPC 29/33 K

(57) ABSTRACT

A busbar cutting unit for cutting a blidge portion of a busbar plate having a plurality of busbars coupled to each other with the bridge portion so that the busbars serve as electric circuits respectively, includes an attachment portion to which the busbar plate is attached, a reception portion that receives bridge pieces formed by cutting the bridge portion of the busbar plate when the bridge portion of the busbar plate is pressed down toward the attachment portion, and a welding portion that is made of an electrical insulation material and is welded to the bridge pieces received in the reception portion.

### CROSS REFERENCE TO RELATED APPLICATIONS

This application is a continuation of PCT application No. PCT/JP2012/069528, which was filed on Jul. 25, 2012 based on Japanese Patent Application (No. 2011-165205) filed on Jul. 28, 2011, the contents of which are incorporated herein by reference.

### BACKGROUND OF THE INVENTION

1. Field of the Invention

The present invention relates to a busbar cutting unit and an interior illumination device for a vehicle.

2. Description of the Related Art

As an interior illumination device for a vehicle to be attached to a ceiling of a vehicle such as an automobile or the like, the interior illumination device in which an electric circuit is formed of a plurality of conductive metallic busbars, is proposed in order to simplify wiring and to improve reliability while eliminating an electric circuit formed by branching two of more electric wires (e.g., see JP-A-2001-180372).

In the interior illumination device for the vehicle shown in JP-A-2001-180372, a busbar plate having a plurality of busbars coupled to each other with bridge portions, is used. A pin fixed to a pressing machine is pressed down toward the bridge portion of the busbar plate attached to an attachment portion of the interior illumination device for a vehicle, and thereby the bridge portion is cut down. Therefore, an operation time period can be reduced as well as an attaching operation can be simplified as compared to a case where the plurality of busbars are attached to respective predetermined attachment portions.

### SUMMARY OF THE INVENTION

However, in the related interior illumination device for a vehicle as shown in JP-A-2001-180372, since cut bridge pieces become in an air-insulated state, a carbon fiber or the like included in an interior member of a vehicle may be contacted with the bridge pieces, a metal chip may be contacted with the bridge pieces or the bridge pieces may swing to be contacted with each other. As a result, a problem may arise that the bridge pieces are electrically connected to be short-circuited to each other.

A purpose of the present disclosure is to solve the problem. That is, the purpose of the present disclosure is to provide a busbar cutting unit capable of preventing bridge portions of a busbar plate from being short-circuited to each other, and an interior illumination device for a vehicle capable of preventing bridge portions of a busbar plate from being short-circuited to each other.

In order to achieve the above purpose, there is provided a busbar cutting unit for cutting a blidge portion of a busbar plate having a plurality of busbars coupled to each other with the bridge portion so that the busbars serve as electric circuits respectively, the busbar cutting unit comprising: an attachment portion to which the busbar plate is attached; a reception portion that receives bridge pieces formed by cutting the bridge portion of the busbar plate when the bridge portion of the busbar plate is pressed down toward the attachment portion; and a welding portion that is made of an electrical insulation material and is welded to the bridge pieces received in the reception portion.

For example, the reception portion has a hole portion for receiving the bridge pieces, and the welding portion is provided on a peripheral edge portion of the hole portion of the reception portion.

There is also provided a busbar cutting method comprising: providing a busbar plate having a plurality of busbars which are coupled to each other with a bridge portion; forming bridge pieces by cutting the bridge portion of the busbar plate so that the busbars serve as electric circuits respectively when the bridge portion of the busbar plate is pressed down toward the attachment portion; and welding a welding portion made of an electrical insulation material to the bridge pieces received in a reception portion.

There is also provided an interior illumination device for a vehicle including the busbar cutting unit.

In accordance with the first aspect of the present disclosure, since the busbar cutting unit is configured such that the attachment portion to which the busbar plate is to be attached is provided with the reception portion that receives bridge pieces formed in such a manner that the bridge portion is pressed down toward the attachment portion and is cut, and the welding portion having the electrical insulation property that is to be welded to the bridge pieces, the bridge pieces are electrically insulated from each other by the welding portion having the electrical insulation property. With this, it is possible to prevent the bridge pieces from being short-circuited to each other and to cause the plurality of busbars to be electrically insulated from each other.

In addition, since the welding portion having the electrical insulation property is welded to the bridge pieces, the busbar cutting unit restricts swinging of the bridge pieces so as to prevent the bridge pieces from being short-circuited to each other. With this, it is possible to make the plurality of busbars attached to the attachment portion to be electrically insulated from each other for sure.

In the busbar cutting unit, in a case where the welding portion having the electrical insulation property is welded to the bridge pieces, the melted welding portion covers the bridge pieces so that it is possible to prevent a metal chip, a carbon fiber, or the like from being contacted with the bridge pieces. With this, it is possible to prevent the bridge pieces from being short-circuited to each other and to make the plurality of busbars to be electrically insulated from each other for sure.

In accordance with the second aspect of the present disclosure, in the busbar cutting unit, the reception portion is formed in a hole shape and the welding portion is formed by being provided and erected at the peripheral edge portion of the reception portion. As a result, inputting of the bridge pieces into the reception portion formed in the hole shape and welding of the welding portion provided and erected at the peripheral edge portion of the reception portion to the bridge pieces can be carried out in a simple structure.

In the busbar cutting unit, since the welding portion is formed by being provided and erected at the peripheral edge portion of the reception portion, the reception portion and the welding portion are placed at the same position so that cutting of the bridge portion and welding of the welding portion can be carried out at the same position. With this, in a case where a cutting unit for the bridge portion and a welding unit for the welding portion are installed in a cutting device, the welding of the welding portion to the bridge pieces can be carried out simultaneously with the cutting of the bridge portion. Therefore, the cutting of the bridge portion and the welding of the welding portion to the bridge pieces can be carried out in a single process so that the operating efficiency can be improved.

In the busbar cutting unit, since the reception portion and the welding portion are placed at the same position, the bridge pieces are welded in the reception portion by the welding portion so that the bas bar can be fixed to the attachment portion by the welding portion. With this, it is possible to reduce the number of fixing pins for attaching the busbars and to miniaturize the busbar cutting unit.

In accordance with the third aspect of the present disclosure, the busbar cutting method is configured such that the bridge portion is pressed down toward the reception portion of the attachment portion of the busbar plate and is cut to form the bridge pieces, the bridge pieces are allowed to be received by the reception portion, and then the welding portion having the electrical insulation property is welded to the bridge pieces. As a result, the bridge pieces are electrically insulated from each other by the welding portion having the electrical insulation property which is welded to the bridge pieces received by the reception portion. Consequently, it is possible to prevent the bridge pieces from being short-circuited to each other and to make the plurality of busbars to be electrically insulated from each other.

In the busbar cutting method, since the welding portion having the electrical insulation property is welded to the bridge pieces, swinging of the bridge pieces is restricted so that it is possible to prevent the bridge pieces from being short-circuited to each other. With this, it is possible to make the plurality of busbars attached to the attachment portion to be electrically insulated from each other for sure.

In the busbar cutting method, in a case where the welding portion having the electrical insulation property is welded to the bridge pieces, the melted welding portion covers the bridge pieces. As a result, it is possible to prevent a metal chip, a carbon fiber or the like from being contacted with the bridge pieces. With this, it is possible to prevent the bridge pieces from being short-circuited to each other and to make the plurality of busbars to be electrically insulated from each other for sure.

In accordance with the fourth aspect of the present disclosure, the interior illumination device for a vehicle is configured such that the attachment portion to which the busbar plate is to be attached is provided with the busbar cutting unit according to the first or second aspect of the present disclosure. As a result, it is possible to make the bridge pieces to be electrically insulated from each other for sure and to prevent the bridge pieces from being electrically short-circuited to each other.

In the interior illumination device for a vehicle, since the attachment portion to which the busbar plate is to be attached is provided with the busbar cutting unit according to the first or second aspect of the present disclosure, it is possible to simplify its structure.

In the interior illumination device for a vehicle, since the attachment portion to which the busbar plate is to be attached is provided with the busbar cutting unit according to the first or second aspect of the present disclosure, it is possible to improve the operating efficiency.

In the interior illumination device for a vehicle, since the attachment portion to which the busbar plate is attached is provided with the busbar cutting unit according to the first aspect or the second aspect, it is possible to reduce its size.

### BRIEF DESCRIPTION OF THE DRAWINGS

FIG. 1 is a perspective view showing an interior illumination device for a vehicle at a cover lens side according to an embodiment of the present disclosure.

FIG. 2 is a perspective view showing the interior illumination device for a vehicle at a housing side shown in FIG. 1.

FIG. 3 is a plan view showing a state that a busbar plate is attached to an attachment portion of a housing.

FIG. 4 is an enlarged view showing a main part of the busbar plate attached to the attachment portion.

FIGS. 5A and 5B are perspective views showing a main part of the attachment portion. FIG. 5A is a schematic view showing a state before the busbar plate is attached to the attachment portion, and FIG. 5B is a schematic view showing a state after the busbar plate is attached to the attachment portion.

FIGS. 6A and 6B are cross sectional views showing the main part of the busbar plate attached to the attachment portion. FIG. 6A is a schematic view showing a state that the busbar plate is attached to the attachment portion, and FIG. 6B is a schematic view showing a state that a welding portion is welded to bridge pieces formed by cutting a bridge portion.

FIG. 7 is an exploded view showing the interior illumination device for a vehicle shown in FIG. 1.

FIG. 8 is a diagram showing a circuit of the interior illumination device for a vehicle.

FIG. 9 is a perspective view showing a state that the busbar plate and clips are assembled to the housing.

FIG. 10 is a perspective view showing a state that switches are assembled to the housing.

FIG. 11 is a perspective view showing a state that electric bulbs are assembled to the housing.

FIG. 12 is a perspective view showing a state that a cover lens is attached to the housing.

### DETAILED DESCRIPTION OF THE EXEMPLARY EMBODIMENTS

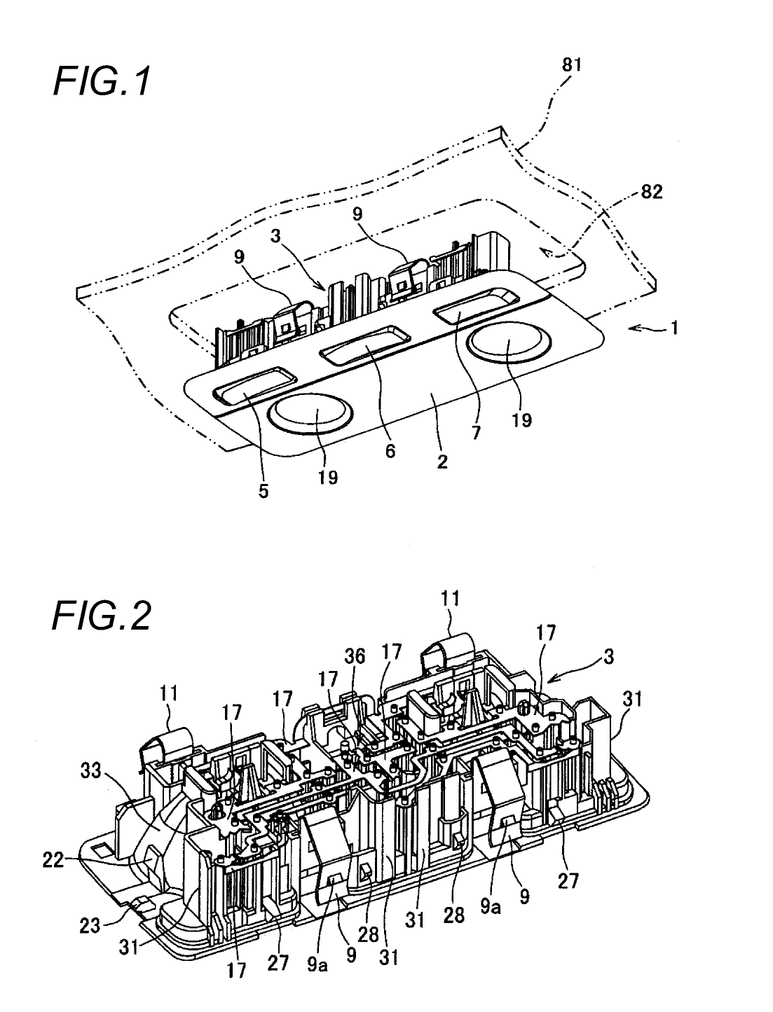

An embodiment of the present disclosure is described below with reference to accompanying FIGS. 1 to 12.

An interior illumination device 1 for a vehicle according to an embodiment of the present disclosure includes a cover lens 2 to be fitted to an opening section 82 at a front face side of a ceiling plate 81 of a ceiling in a vehicle such as an automobile or the like, a housing 3 accommodated in the opening section 82 at a rear face side, switch knobs 5 and 7 for lighting and a switch knob 6 for door-interlocking lighting as shown in FIG. 1.

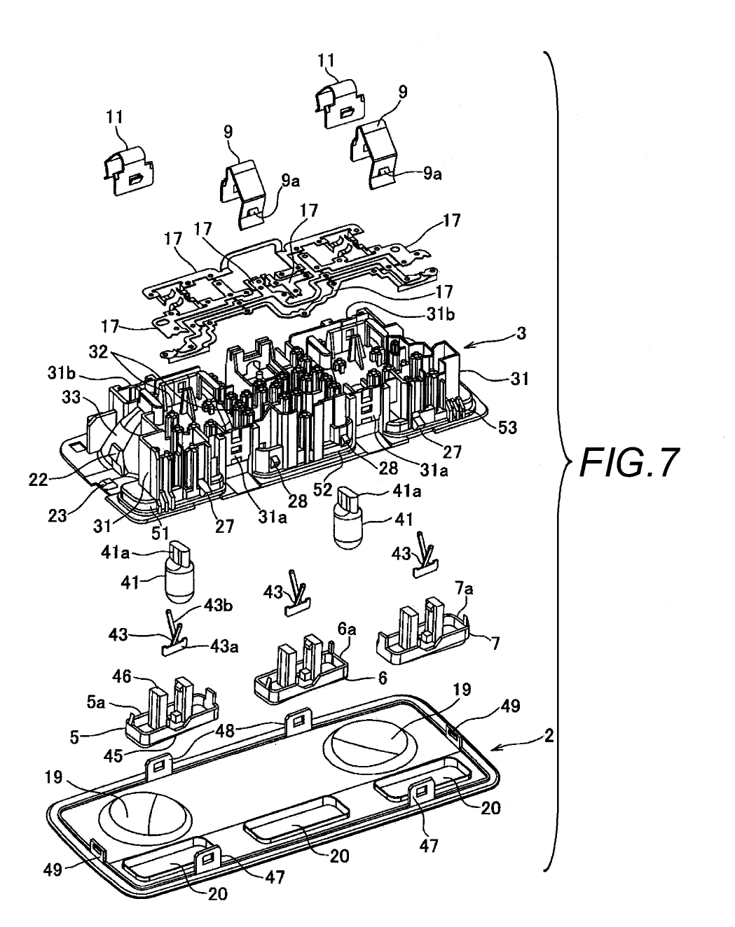

The cover lens 2 is formed in a rectangular thin plate shape as shown in FIG. 7. The cover lens 2 has opening sections 20 for the switch knobs 5 and 7 for lighting and the switch knob 6 for door-interlocking lighting, lens sections 19 for passing light of electric bulbs 41 provided in the housing 3, and latch sections 47, 48 and 49 to be latched to the housing 3. The cover lens 2 is formed from a synthetic resin having an electrical insulation property such as a polypropylene resin, a polyvinyl chloride resin or the like.

The opening section 20 is disposed on a straight line along a long side direction of the cover lens 2. The opening sections 20 respectively disposed on the cover lens 2 at both end sides in the long side direction thereof are opened in rectangular shapes along the outer shapes of the switch knobs 5 and 7 for lighting. The opening section 20 disposed at a center side of the cover lens 2 is opened in a rectangular shape along the outer shape of the switch knob 6 for door-interlocking lighting.

The lens sections 19 are disposed on the cover lens 2 at both end sides thereof in the long side direction, respectively. In the lens sections 19, lens faces are formed so as to allow the light of electric bulbs 41 to illuminate respective portions in the vehicle.

The latch sections 47, 48 and 49 are formed in wall shapes projected from the rear face of the cover lens 2. The latch sections 47, 48 and 49 respectively have holes to which latch pawls 23 and 27 (described later) of the housing 3 are respectively latched. The latch sections 47 are disposed on an end portion of the cover lens 2 at the opening section 20 side in a short side direction thereof. The latch sections 48 are disposed on an end portion of the cover lens 2 at the lens 19 side in the short side direction thereof. The latch sections 49 are disposed on respective end portions of the cover lens 2 in the long side direction thereof.

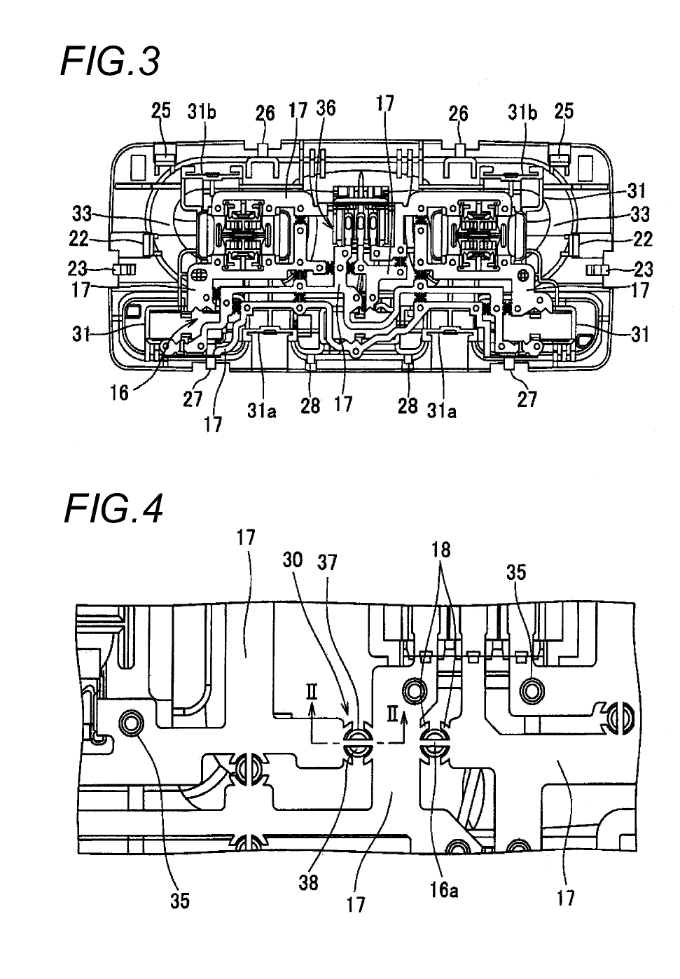

As shown in FIGS. 2 and 3, the housing 3 is formed in a rectangular shape and the cover lens 2 is attached to the housing 3. The housing 3 includes a peripheral wall section 31 provided and erected at a peripheral edge section, an attachment portion 32 (FIGS. 7A and 7B) provided and erected at the inside of the peripheral wall section 31, a plurality of busbars 17 attached to the attachment portion 32, clips 9 and 11 attached to the peripheral wall section 31, and recessed sections 33 into which the electric bulb 41 are respectively fitted to be fixed thereto. The housing 3 is formed from an synthetic resin having an electrical insulation property such as a polypropylene resin, a polyvinyl chloride resin or the like.

The peripheral wall section 31 is adapted to accommodate electric circuits (described later) formed of the plurality of busbars 17 and is formed along outer shapes of the electric circuits. With this, the electric circuits are protected from the outside by the peripheral wall section 31. As shown in FIGS. 3 and 7, the peripheral wall section 31 is provided with clip attachment portions 31a and 31b (described later) to which the clips 9 and 11 are attached, latch pawls 23, 26 and 27 which are to be latched to the latch sections 47, 48 and 49 of the cover lens 2, and latch pawls 22, 25 and 28 which are latched to an attachment member (not shown) provided at the rear face side of the ceiling plate 81.

The clip attachment portions 31a and 31b respectively have guide portions which are provided along the peripheral wall section 31 so as to slid and guide the clips 9 and 11, and engagement projections which are to be engaged with the respective slid clips 9 and 11.

The latch pawls 23, 26 and 27 are formed so as to be extended toward the outside from the peripheral edge section of the housing 3, and are formed in triangle shapes so as to be latched to holes respectively provided on the latch sections 49, 48 and 47 of the cover lens 2. The latch pawls 23 are provided on the housing 3 at both end sides in the long side direction thereof, respectively. The latch pawls 26 are provided on the housing 3 at a recessed section 33 side in the short side direction thereof. The latch pawls 27 are provided on the housing 3 at the opening section 20 side of the cover lens 2 attached to the housing 3 in the short side direction of the housing 3.

The latch pawls 22, 25 and 28 are provided and erected on the housing 3 along the peripheral wall section 31. The latch pawls 22, 25 and 28 are formed in triangle shapes such that each of the tip portions is projected toward the outside. The latch pawls 22 are respectively disposed on the housing 3 at both end sides in the long side direction thereof. The latch pawls 25 are disposed on the housing 3 at the recessed section 33 side in the short side direction of the housing 3 and are respectively provided at both end sides in the long side direction of the housing 3. The latch pawls 28 are disposed on the housing 3 in the short side direction thereof at the opening section 20 side of the cover lens 2 attached to the housing 3.

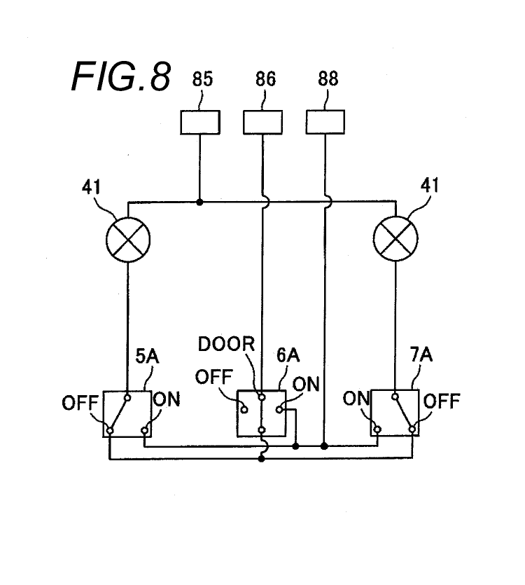

The attachment member is provided with a wire harness connected to a power source 8 (shown in FIG. 8), an ECU 86 or a ground 88. The attachment member has terminal sections electrically contacted with electric contact terminals which are formed on the plurality of busbars 17 of the housing 3 and are to be connected with the power source 8, the ECU 86 or the ground 88 when the interior illumination device 1 for a vehicle is attached to the attachment member, and latch sections to be latched to the latch pawls 22, 25 and 28 of the peripheral wall section 31 of the housing 3.

The attachment portion 32 is provided along the shapes of the electric circuits which are formed by the plurality of the busbars 17 to be attached to the attachment portion 32. As shown in FIG. 4, the attachment portion 32 is provided with fixing pins 35 for fixing the plurality of busbars 17 to the attachment portion 32 at the tip portion, and a busbar cutting unit 30 which is adapted to cut a bridge portion 16a coupling the plurality of busbars 17 with each other and is welded to bridge pieces 16c formed by cutting the bridge portion 16a.

As shown in FIG. 4, each of the fixing pins 35 is formed in a cylindrical column having a projection amount which is determined such that the top ends of the fixing pins 35 are projected from the plurality of busbars 17 when the busbars 17 are attached to the attachment portion 32. The fixing pins 35 are welded to the plurality of busbars 17 by ultrasonic welding or thermal welding.

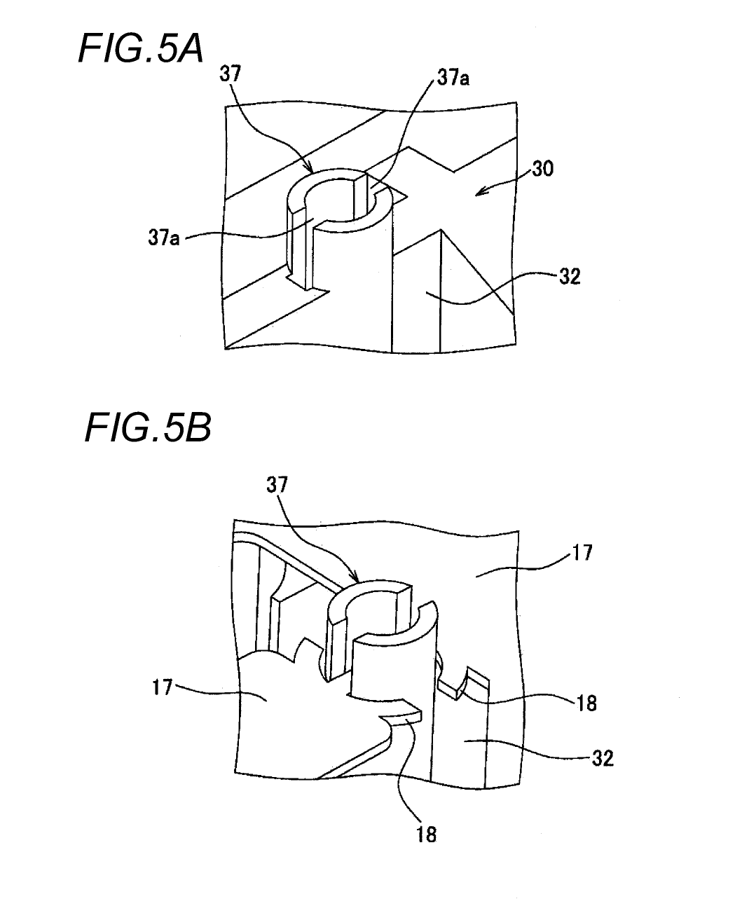

As shown in FIGS. 4 and 5, the busbar cutting unit 30 is configured such that a reception portion 38 that can receive the bridge pieces 16c which are formed in such a manner that the bridge portion 16a of the plurality of busbars 17 is pressed down toward the attachment portion 32 and is cut, and a welding portion 37 having an electrical insulation property which is to be welded to the bridge pieces 16c received by the reception portion 38 are provided on the attachment portion 32. The reception portion 38 and the welding portion 37 are disposed at a portion where the bridge portion 16a of the attachment portion 32 is disposed.

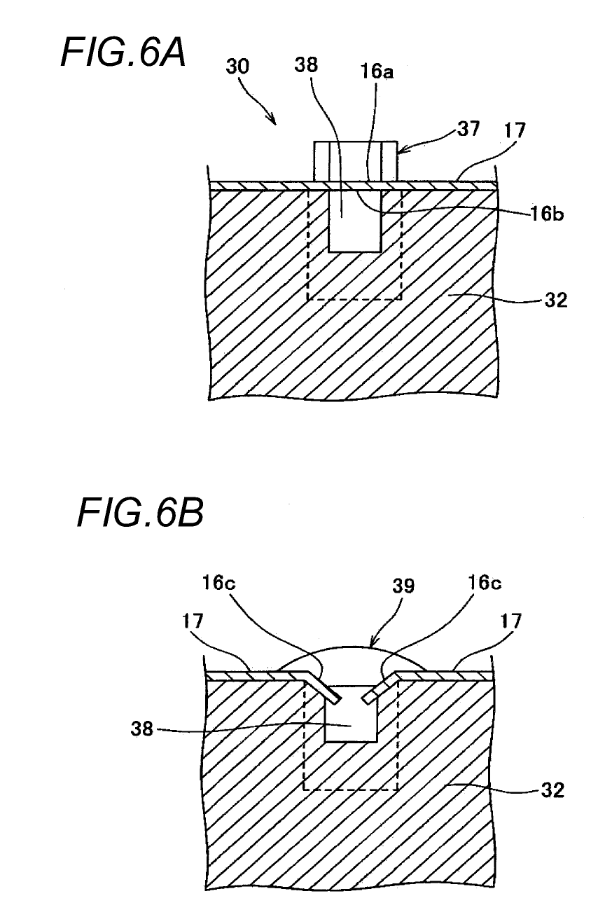

As shown in FIGS. 4 and 6A, the reception portion 38 is formed in a hole shape. The reception portion 38 is formed such that a hole diameter and a depth thereof are determined so as to receive the bridge pieces 16c. The reception portion 38 is formed such that the hole diameter and the depth thereof are determined so as to receive a pin as a cutting unit of a cutting device for cutting the bridge portion 16a.

As shown in FIGS. 4, 5A and 6A, the welding portion 37 is provided and erected at a peripheral edge portion of the reception portion 38 and is formed in a cylindrical shape. As shown in FIG. 5A, the welding portion 37 is provided with a notch portion 37a into which the bridge portion 16a is inserted. The welding portion 37 is formed from a synthetic resin having an electrical insulation property together with the housing 3.

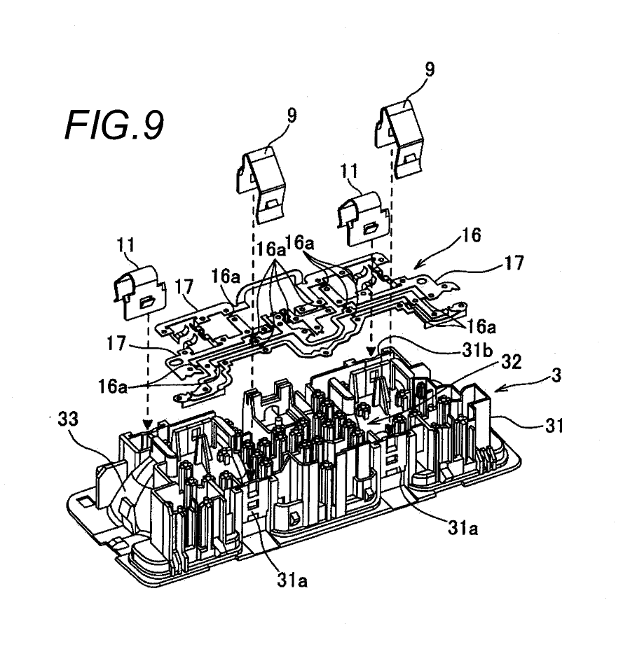

As shown in FIGS. 2 and 3, the plurality of (e.g., six in the drawings) busbars 17 are attached to the attachment portion 32. The plurality of busbars 17 are formed in respective predetermined shapes so as to function as respective predetermined electric circuits. A contact point which is turned on or off by an external operation, a terminal to be connected to the electric bulb 41 and an electric contact terminal to be connected to the power source 8, the ECU 86 or the ground 88 are formed on the bas bars 17. As shown in FIGS. 3 and 9, before the plurality of busbars 17 are attached to the attachment portion 32, the plurality of busbars 17 are coupled to each other with the coupling sections 16a to form the busbar plate 16.

The busbar plate 16 is provided with the plurality of busbars 17 formed in the respective predetermined shapes, and the plurality of bridge portions 16a coupling the plurality of busbars 17 among each other. The busbar plate 16 is formed in such a manner that the plurality of busbars 17 and the plurality of bridge portions 16a are formed from a conductive metallic plate by a punching process and are folded by a press process, and thereby the busbar plate 16 is formed in a predetermined shape.

As shown in FIGS. 4 and 5, each of the bridge portions 16a is formed in a width whereby it can be cut by the pin of the cutting device. Each of the bridge portions 16a is provided with a groove portion 16b as shown in FIG. 6A. With this, when the pin of the cutting device is pressed down toward the attachment portion 32, each of the bridge portion 16a is cut from the groove portion 16b. Therefore, each of the bridge portions 16a can be cut at the center portion of the reception portion 38.

A pair of restriction pieces 18 which are extended from an edge end section of the busbar 17 and are formed in arc shapes along the outer shape of the welding portion 37, are provided in the vicinity of each of the bridge portion 16a. With this, it is possible to prevent the central portion of each bridge portion 16a from being shifted from the central portion of the reception portion 38. Therefore, the bridge portions 16a can be accurately cut.

As shown in FIG. 7, the clips 9 and 11 are formed such that a metallic plate is subjected to a punching process and a pressing process. The clips 9 and 11 respectively have engagement portions to be engaged with engagement projections respectively provided at the clip attachment portions 31a and 31b, and latch projections 9a which are latched to the attachment member when the housing 3 is attached to the attachment member at the rear face side of the ceiling plate 81.

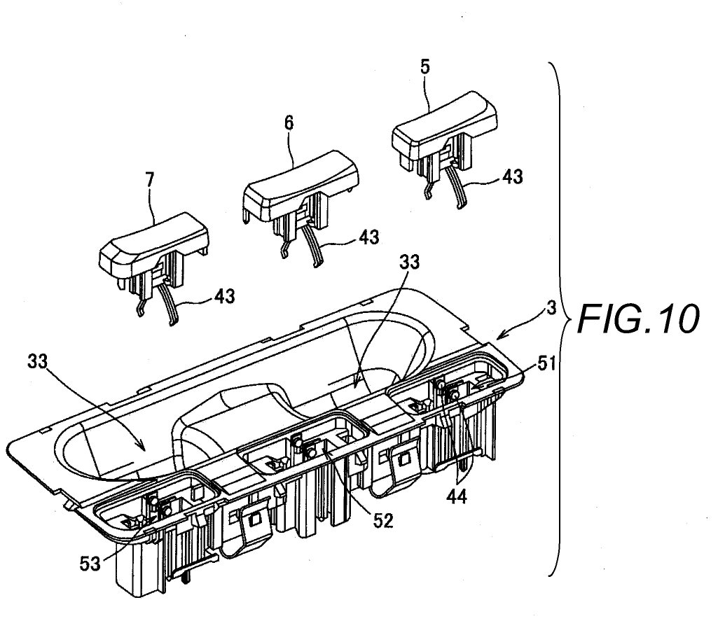

As shown in FIGS. 3 and 10, the recessed sections 33 are respectively provided on the housing 3 at both end sides of the housing 3 in the long side direction thereof. The recessed sections 33 are formed in elliptical shapes and constituted such that the electric bulbs 41 are fitted into respective bottom portions and fixed thereto.

Each of the electric bulbs 41 is, for example, a halogen electric bulb having a mouthpiece of G4. Regarding the specifications of the electric bulbs 41, for example, a voltage is 12V and a power consumption is 10 W. Meanwhile, the electric bulbs 41 can be light emitting diode (LED) electric bulbs other than halogen electric bulbs. The voltage or the power consumption is not limited to the above example.

As shown in FIG. 7, switch knobs 5 and 7 for lighting respectively have knob bodies 5a and 7a which are exposed from the opening sections 20 of the cover lens 2 at both end sides in the long side direction and are operated to be turned on or off by a driver or the like, and terminal metal fittings 43 to be contacted with the contact points of the busbars 17 which are turned on or off by external operation.

The knob bodies 5a and 7a respectively have fitting sections 46 which are provided and erected at the knob bodies 5a and 7a and into which the terminal metal fittings 43 are fitted to be fixed, and bearing sections 45 which are provided on the fitting sections 46 at the base end sides and are pivoted on shaft sections 44 (shown in FIG. 10) of knob attachment portions 51 and 53 disposed at both end sides of the housing 3.

The terminal metal fittings 43 respectively have top portions 43a to be fitted into the fitting sections 46, terminals which are always in contact with the busbars 17 supplied with power from the power source 85, and terminals each of which is contacted with either one of the busbar 17 connected to the ground 88 and the busbar 17 connected to the switch knob 6 for door-interlocking lighting by external operation.

The switch knob 6 for door-interlocking lighting has a knob body 6a which is exposed from the opening section 20 of the cover lens 2 at the center side and is operated to be turned on or off by a driver or the like, and a terminal metal fitting 43 to be contacted with a contact point of the busbar 17 which is turned on or off by external operation.

The knob body 6a has a fitting section 46 which is provided and erected at the knob body 6a and into which the terminal metal fitting 43 is fitted to be fixed, and a bearing section 45 which is provided on the fitting section 46 at the base end side and is pivoted on a shaft section 44 of knob attachment portion 52 disposed at the center side of the housing 3.

The terminal metal fitting 43 has a top portion 43a to be fitted into the fitting section 46, a terminal which is always in contact with the busbar 17 which is contacted with the terminal metal fittings 43 of the switch knobs 5 and 7 for lighting when the switch knobs 5 and 7 are turned off, and a terminal which is contacted with either one of the busbar 17 electrically connected to the ECU 86, the busbar 17 electrically connected to the ground 88 and an opening section not electrically connected, by external operation.

Next, an electric circuit of the interior illumination device 1 for a vehicle constituted as in the above, is described below.

As shown in FIG. 8, the electric circuit of the interior illumination device 1 for a vehicle is constituted such that a switch 5A for lighting to be operated by the switch knob 5 for lighting, the electric bulb 41 and the power source 85 are connected in series, and a switch 6A for lighting to be operated by the switch knob 6 for lighting, the electric bulb 41 and the power source 85 are connected in series. When turning on, the switch 6A for door-interlocking lighting operated by the switch knob 6 for door-interlocking lighting is connected to the ground 88. When turning off, the switch 6A is opened. When being in a door-interlocking state, the switch 6A is connected to the ECU 86.

Next, a method of assembling the interior illumination device 1 for a vehicle constituted as in the above, is described below.

First, as shown in FIG. 9, the busbar plate 16 is attached to the attachment portion 32 having, provided thereon, the busbar cutting unit 30 of the housing 3 and the clips 9 and 11 are attached to the respective clip attachment portions 31a and 31b of the peripheral wall section 31.

At that time, as shown in FIGS. 4, 5B and 6A, each of the plurality of bridge portions 16a of the busbar plate 16 is positioned between the pair of restriction pieces 18 provided on the busbar 17 so that the bridge portion 16a is disposed at the central portion of the reception portion 38.

Next, the pin of the cutting device is pressed down toward the attachment portion 32, the bridge portion 16a of the busbar plate 16 is pressed down toward the attachment portion 32 by the pin, and thereby the bridge portion 16a is cut as shown in FIG. 6B. At that time, since a welding unit for welding the welding portion 37 is provided on the pin of the cutting device, the welding portion 37 is formed in a hemisphere shape and is welded to the bridge pieces 16c. Since the bridge pieces 16c are buried in the welding portion 37 which is welded in the hemisphere shape, it is possible to prevent short-circuiting which may occur when a metal chip, a carbon fiber or the like is contacted with the bridge piece 16c or the bridge pieces 16c are swung and contacted with each other.

Meanwhile, as the welding unit, an ultrasonic oscillator, a heat chip or the like is provided in the vicinity of the pin. As the welding method, an ultrasonic welding, a thermal welding (impulse welding) or the like is used.

Next, as shown in FIG. 10, the switch knobs 5 and 7 for lighting having the terminal metal fittings 43 fitted thereinto, and the switch knob 6 for door-interlocking lighting are respectively fitted into the knob attachment portions 51, 52 and 53 of the housing 3, the shaft sections 44 of the knob attachment portions 51 and 53 are inserted into the bearing sections 45 of the switch knob bodies 5a and 7a for lighting, and then the bearing section of the knob attachment portion 52 is inserted into the bearing section 45 of the switch knob body 6a for door-interlocking lighting. At that time, the switch knobs 5 and 7 for lighting and the switch knob 6 for door-interlocking lighting are attached to the knob attachment portions 51, 52 and 53 of the housing 3 so as to be subjected to ON/OFF operations.

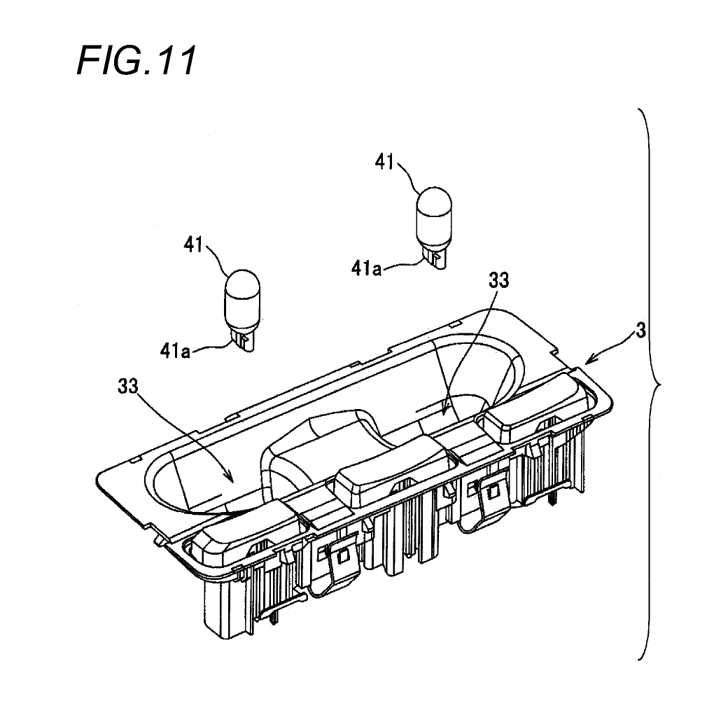

Next, as shown in FIG. 11, the electric bulbs 41 are pushed into the respective recessed sections 33 of the housing 3, and then the electric bulbs 41 are fixed to the recessed sections 33, respectively. At that time, the electric bulbs 41 are electrically connected to the respective busbars 17 having formed thereon the terminals to be connected to the electric bulbs 41.

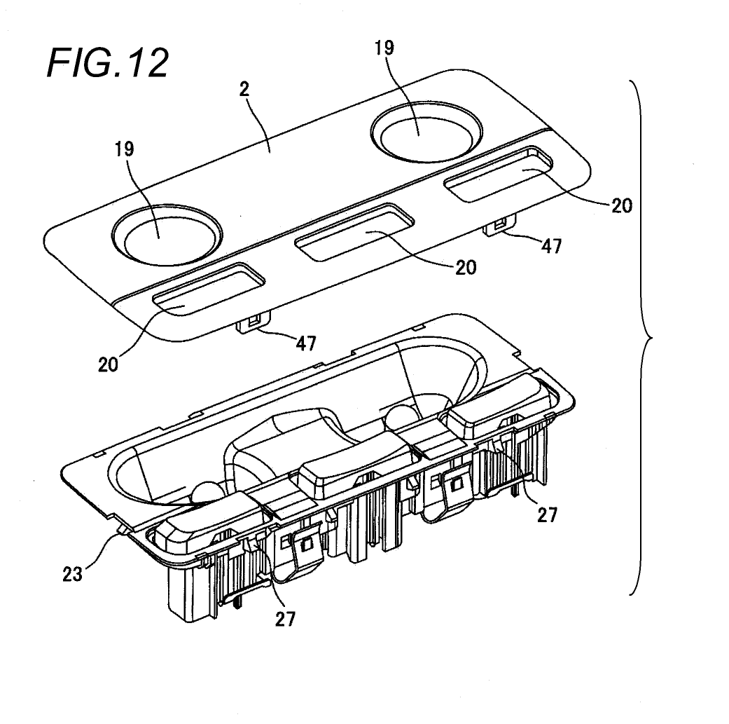

Next, as shown in FIG. 12, the cover lens 2 is attached to the housing 3. At that time, the latch pawls 23, 26 and 27 of the housing 3 and the latch sections 47, 48 and 49 of the cover lens 2 are respectively latched among each other, and thereby the cover lens 2 is fixed to the housing 3.

In accordance with the embodiment, the busbar cutting unit 30 is configured such that the plurality of busbars 17 are coupled to each other with the bridge portion 16a to form the busbar plate 16, and the bridge portion 16a of the busbar plate 16 is cut to make the plurality of busbars 17 to be the respective electric circuits. In the busbar cutting unit 30, the attachment portion 32 to which the busbar plate 16 is attached, is provided with the reception portion 38 which receives the bridge pieces 16c formed in such a manner that the bridge portion 16a is pressed down toward the attachment portion 32 and is cut, and the welding portion 37 having the electrical insulation property which is to be welded to the bridge pieces 16c received by the reception portion 38.

With the above, the busbar cutting unit 30 is configured such that the attachment portion 32 provided with the busbar plate 16 includes the reception portion 38 which receives the bridge pieces 16c formed in such a manner that the bridge portion 16a is pressed down toward the attachment portion 32 and is cut, and the welding portion 37 having the electrical insulation property which is to be welded to the bridge pieces 16c received by the reception portion 38. The bridge pieces 16c are made to be electrically insulated by the welding portion 37 having the electrical insulation property welded to the bridge pieces 16c. Therefore, it is possible to prevent the bridge pieces 16c from being short-circuited to each other and to make the plurality of busbars 17 to be electrically insulated from each other.

In the busbar cutting unit 30, since the welding portions 37 each having the electrical insulation property are welded to the bridge pieces 16c, the busbar cutting unit 30 restricts swinging of the bridge pieces 16c and prevents the bridge pieces 16c from being short-circuited to each other. With this, it is possible to make the plurality of busbars 17 attached to the attachment portion 32 to be electrically insulated from each other for sure.

Since the melted welding portion 37 covers the bridge pieces 16c when the welding portion 37 having the electrical insulation property is welded to the bridge pieces 16c, the busbar cutting unit 30 prevents a metal chip, a carbon fiber or the like from being contacted with the bridge pieces 16c. With this, it is possible to prevent the bridge pieces 16c from being short-circuited to each other and to make the plurality of busbars 17 to be electrically insulated from each other for sure.

In accordance with the embodiment, the busbar cutting unit 30 is configured such that the reception portion 38 is formed in a hole shape and the welding portion 37 is provided and erected at the peripheral edge portion of the reception portion 38.

Therefore, since the busbar cutting unit 30 is configured such that the reception portion 38 is formed in the hole shape and the welding portion 37 is provided and erected at the peripheral edge portion of the reception portion 38, inputting of the bridge pieces 16c into the reception portion 38 formed in the hole shape and welding of the welding portion 37 provided and erected at the peripheral edge portion of the reception portion 38 to the bridge pieces 16c can be carried out in a simple structure.

In addition, since the busbar cutting unit 30 is configured such that the welding portion 37 is provided and erected at the peripheral edge portion of the reception portion 38, the reception portion 38 and the welding portion 37 are placed at the same position so that the cutting of the bridge portion 16a and the welding of the welding portion 37 can be carried out at the same position. With this, in a case where the cutting unit of the bridge portion 16a and the welding unit of the welding portion 37 are provided on the cutting device, the welding of the welding portion 37 to the bridge pieces 16c can be carried out simultaneously with the cutting of the bridge portion 16a. Consequently, cutting of the bridge portions 16a and the welding of the welding portion 37 to the bridge pieces 16c can be carried out in a single process, so that the operating efficiency can be improved.

In the busbar cutting unit 30, since the reception portion 38 and the welding portion 37 are placed at the same position, the bridge pieces 16c are welded to a portion in the reception portion 38 by the welding portion 37 so that the busbar 17 can be fixed to the attachment portion 32 by the welding portion 37. Therefore, it is possible to reduce the number of fixing pins 35 for attaching the busbars 17 and to miniaturize the busbar cutting unit 30.

Further, in accordance with the embodiment, the busbar cutting method is configured such that the bridge portions 16a of the busbar plate 16 having the plurality of busbars 17 coupled among each other with the bridge portions 16a are cut to make the plurality of busbars 17 to be the respective electric circuits. In the busbar cutting method, the busbars 17 are pressed down toward the reception portions 38 provided at the attachment portion 32, to which the busbar plate 16 is to be attached, and thereby the bridge portions 16a are cut so as to form the bridge pieces 16c, the bridge pieces 16c are allowed to be received by the respective reception portions 38, and then the welding portions 37 each having the electrical insulation property are welded to the respective bridge pieces 16c.

With this, in the busbar cutting method, the bridge portions 16a are pressed down toward the respective reception portions 38 of the attachment portion 32 of the busbar plate 16 and are cut to form the bridge pieces 16c, the bridge pieces 16c are allowed to be received by the reception portions 38, and then the welding portions 37 each having the electrical insulation property are welded to the respective bridge pieces 16c. As a result, the bridge pieces 16c are made to be electrically insulated from each other by the welding portions 37 each having the electrical insulation property welded to the bridge pieces 16c received by the reception portions 38. Consequently, it is possible to prevent the bridge pieces 16c from being short-circuited to each other and to make the plurality of busbars 17 to be electrically insulated from each other.

In the busbar cutting method, since the welding portions 37 each having electrical insulation property are welded to the bridge pieces 16c, swinging of the bridge pieces 16c is restricted so that so that it is possible to prevent the bridge pieces 16c from being short-circuited to each other. With this, it is possible to make the plurality of busbars 17 attached to the attachment portion 32 to be electrically insulated from each other for sure.

In the busbar cutting method, since the bridge pieces 16c are covered with the melted welding portion 37 having the electrical insulation property when the welding portion 37 is welded to the bridge pieces 16c, it is possible to prevent a metal chip, a carbon fiber or the like from being contacted with the bridge pieces 16c. With this, it is possible to prevent the bridge pieces 16c from being short-circuited to each other and to make the plurality of busbars 17 to be electrically insulated from each other for sure.

Furthermore, in the busbar cutting method according to the embodiment, the reception portion 38 is formed in the hole shape and the welding portion 37 is provided and erected at the peripheral edge portion of the reception portion 38. As a result, inputting of the bridge pieces 16c into the reception portion 38 formed in the hole shape and welding of the welding portion 37 provided and erected at the peripheral edge portion of the reception portion 38 to the bridge pieces 16c can be readily carried out.

In the busbar cutting method, the welding portion 37 is provided and erected at the peripheral edge portion of the reception portion 38, the reception portion 38 and the welding portion 37 are placed at the same position so that the cutting of the busbar 17 and the welding of the welding portion 37 can be carried out at the same position. With this, in a case where the cutting unit of the bridge portion 16a and the welding unit of the welding portion 37 are provided on the cutting device, the welding of the welding portion 37 to the bridge pieces 16c can be carried out simultaneously with the cutting of the bridge portion 16a. Consequently, cutting of the bridge portions 16a and the welding of the bridges 16c to the welding portions 37 can be carried out in a single process, so that the operating efficiency can be improved.

In the busbar cutting method, since the reception portion 38 and the welding portion 37 are placed at the same position, the bridge pieces 16c are welded to a portion in the reception portion 38 by the welding portion 37 so that the busbar 17 can be fixed to the attachment portion 32 by the welding portion 37. Consequently, it is possible to reduce the number of fixing pins 35 for attaching the busbars 17 and to miniaturize the busbar cutting unit 30.

Furthermore, in accordance with the embodiment, since the interior illumination device 1 for a vehicle has the busbar cutting unit 30, it is possible to make the bridge pieces 16c to be electrically insulated from each other for sure and to prevent the bridge pieces 16c from being short-circuited to each other.

Since the interior illumination device 1 for a vehicle has the busbar cutting unit 30, the structure thereof can be simplified, the operating efficiency can be improved and the interior illumination device 1 for a vehicle can be miniaturized.

Furthermore, in accordance with the embodiment, since the method of manufacturing the interior illumination device 1 for a vehicle includes the busbar cutting method, it is possible to make the bridge pieces 16c to be electrically insulated from each other for sure and to prevent the bridge pieces 16c from being short-circuited.

Since the method of manufacturing the interior illumination device 1 for a vehicle includes the busbar cutting method, the manufacturing can be performed in a simple structure, the operating efficiency can be improved and the interior illumination device 1 for a vehicle can be miniaturized.

In addition to the interior illumination device 1 for a vehicle, the busbar cutting unit 30 and the busbar cutting method can be applied to an electric connection box and the like in which the bridge portions 16a of the busbar plate 16 are cut so as to cause the busbar plate 16 to be divided into the plurality of busbars 17, and thereby the busbars 17 are used as electric circuits.

While the embodiment is only a representative configuration of the present disclosure, the present disclosure is not limited thereto. That is, various changes can be made without departing from the essence of the present disclosure.

By the above configuration, it is possible to prevent the bridge pieces of the busbar cutting unit from being short-circuited to each other and to cause the plurality of busbars of the busbar plate to be electrically insulated from each other.

What is claimed is:

1. A busbar cutting unit for cutting a blidge portion of a busbar plate having a plurality of busbars coupled to each other with the bridge portion so that the busbars serve as electric circuits respectively, the busbar cutting unit comprising:
an attachment portion to which the busbar plate is attached;
a reception portion that receives bridge pieces formed by cutting the bridge portion of the busbar plate when the bridge portion of the busbar plate is pressed down toward the attachment portion; and
a welding portion that is made of an electrical insulation material and is welded to the bridge pieces received in the reception portion.

2. The busbar cutting unit according to claim 1, wherein the reception portion has a hole portion for receiving the bridge pieces; and
wherein the welding portion is provided on a peripheral edge portion of the hole portion of the reception portion.

3. An interior illumination device for a vehicle comprising:
the busbar cutting unit according to claim 1.
